(19) United States
(12) Patent Application Publication
(10) Pub. No.: US 2026/0245122 A1
(43) Pub. Date: Aug. 20, 2026

(54) SYSTEM FOR AUTOMATED PROCESSING AND SEAMLESS SHARING OF USER-GENERATED RATING AND COMMENT ACROSS DIGITAL PLATFORMS

(71) Applicant: Text S.A., Wroclaw (PL)

(72) Inventor: Agnieszka Jawinska, Wroclaw (PL)

(73) Assignee: Text S.A., Wroclaw (PL)

(21) Appl. No.: 19/055,574

(22) Filed: Feb. 18, 2025

(51) Int. Cl. G06Q 30/0282; G06F 9/54; G06F 16/958; G06F 40/30; G06Q 30/0203; H04L 51/046

(52) U.S. Cl. CPC G06Q 30/0282; G06F 9/547; G06F 16/986; G06F 40/30; G06Q 30/0203; H04L 51/046

(57) ABSTRACT

The present disclosure relates to a system and method for the automated capture, processing, organization and further use of user-generated feedback within real-time communication platforms. The invention comprises a user interaction module for initiating feedback collection, a chat assessment form for capturing user ratings and comments, and a feedback validation and processing unit that ensures compliance with quality standards. Validated feedback is securely stored in a database storage system and accessed through an assessment manager for review by authorized personnel. The system includes an HTML rendering engine that creates a public access link featuring branded graphical representations and structured metadata for consistent presentation. An external sharing module facilitates seamless distribution across various digital platforms. This invention automates the entire feedback lifecycle, enhancing efficiency, reducing manual intervention, and enabling scalable management of large volumes of user feedback. The system is designed to support improved service quality, user satisfaction, and brand visibility.

### BACKGROUND OF THE INVENTION

Claimed subject matter refers to the field of digital communication and feedback management systems, specifically focusing on the automated processing and sharing of user-generated ratings and comments across multiple digital platforms. In the current era of digital customer service and support, particularly within live chat and real-time communication environments, organizations face substantial challenges in effectively capturing, managing, and utilizing user feedback. Despite the recognized importance of user feedback in enhancing service quality, customer satisfaction, and brand credibility, existing systems often lack comprehensive solutions for integrating this feedback into evaluation processes while enabling seamless sharing with external audiences.

The claimed subject matter improves upon the known state of the art as traditional feedback collection methods rely heavily on manual processes, requiring significant time and resources to gather, review, and disseminate user comments. These methods are not only prone to human error but are also inefficient in high-volume environments, leading to inconsistent feedback representation and reduced opportunities for swift response and other actions. Moreover, existing systems typically do not offer integrated solutions that automate the visibility management of feedback, provide real-time processing, or support scalable sharing across multiple platforms. As a result, organizations are unable to fully leverage user feedback to drive service improvements or enhance their online presence effectively.

Previous approaches to feedback management have focused on basic collection through forms or post-interaction surveys. While these methods provide a simple means of gathering user input, they often fail to address the need for real-time processing, automated validation, and consistent sharing across digital platforms. The inability to seamlessly integrate feedback into broader service analysis and public engagement workflows restricts an organization's ability to maintain customer trust and adapt quickly to user insights.

Given these limitations, there is a clear need for an improved system and method that automates the end-to-end process of capturing, validating, storing, and sharing user feedback which is provided by the claimed invention disclosed therein. Claimed subject matter provides real-time integration capabilities, ensures feedback authenticity, and facilitates the effortless distribution of content in a visually appealing and structured format. This would enable organizations to manage user feedback more efficiently, reduce the manual workload, and maximize the impact of positive user experiences by sharing them seamlessly across digital channels.

The disclosed invention addresses these challenges by offering an automated system designed to enhance the feedback lifecycle from collection to public sharing, providing a solution that is scalable, reliable, and adaptable to various digital communication platforms.

### BRIEF SUMMARY OF THE INVENTION

The claimed subject matter provides a system and method for the automated processing, management, and dissemination of user-generated feedback within real-time communication environments. This invention addresses existing limitations by streamlining the capture, validation, and distribution of feedback, ensuring that user comments and ratings can be effectively integrated into evaluation processes and shared across various digital platforms with minimal manual intervention.

In an exemplary embodiment, the system initiates by capturing feedback submitted through a user interaction module after an end-user completes an interaction within a digital communication platform. The feedback, consisting of ratings and comments, is collected via a feedback collection interface and transmitted to a feedback validation and processing unit. This unit performs automated checks to confirm that the feedback meets quality standards before storing it in a secure database storage system.

The stored feedback is accessible through an assessment manager, where authorized personnel can review and manage the data. The system then utilizes an HTML rendering engine to generate a unique public access link that includes branded graphical representations of the feedback, complete with structured metadata. The external sharing module enables seamless distribution of the rendered feedback across multiple digital platforms, ensuring that content is presented in a consistent, professional format that supports brand integrity.

The present invention offers significant improvements over prior art by automating the feedback lifecycle, reducing the need for manual processing, enhancing operational efficiency, and allowing for scalable handling of large volumes of feedback. This results in improved service quality, better customer engagement, and a strengthened online presence for organizations.

### BRIEF DESCRIPTION OF THE SEVERAL VIEWS OF DRAWINGS

Further advantages, features and details of the various embodiments of this disclosure will become apparent from the ensuing description of a preferred exemplary embodiment or embodiments and further with the aid of the drawings. The features and combinations of features recited below in the description, as well as the features and feature combination shown after that in the drawing description or in the drawings alone, may be used not only in the particular combination recited but also in other combinations on their own without departing from the scope of the disclosure.

In the following, advantageous examples of the disclosure are set out with reference to the accompanying drawings, wherein:

FIG. 1 depicts the process flow including the generation and sharing of user-generated feedback;

FIG. 2 depicts the workflow of a real-time communication and feedback collection process; and

FIG. 3 depicts the process of data retrieval and rendering of feedback assessments.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C. In the figures, the same or functionally identical elements have been provided with the same reference signs.

In the contemporary sphere of digital customer service and support, particularly within live chat environments, a substantial challenge exists in the efficient capture, management, and utilization of user feedback. Existing systems frequently lack the capacity to integrate such feedback seamlessly into evaluation and improvement workflows while concurrently facilitating its effective dissemination across multiple platforms. This deficiency results in missed opportunities for organizations to augment service quality, enhance customer satisfaction, and bolster brand visibility.

The disclosed system pertains to a method and system for automated processing and sharing of user-generated ratings and comments across digital platforms. This invention addresses critical deficiencies in existing solutions, particularly those associated with the manual handling and dissemination of user feedback in real-time messaging environments.

The present invention introduces a mechanism that enables efficient capturing, management, and sharing of user-generated content within a communication platform. This includes a seamless integration process that facilitates content evaluation and distribution to external platforms while ensuring content authenticity and maintaining brand integrity. The system is designed to minimize manual intervention, thereby increasing operational efficiency.

The architecture of the system involves multiple components interacting with each other to capture, process, and share user feedback. The primary elements as set out in the figures include:
Live chat handler (103) configured to engage in real-time interaction between an agent (101), also referred to as the first user, and an end-user (109), also referred to as the user. This module facilitates the exchange of messages (102) and serves as the interface for user feedback collection.
The assessment manager (107) is configured to manage the processing of feedback data collected through the chat (110) interface. This component verifies, stores, and updates the visibility status of content.
Database (104) located on the server (105) along with the live chat handler (103) and assessment manager (107) is further configured to store chat history and feedback, ensuring secure and scalable storage solutions. The database (104) interacts with various system components to retrieve and update records.
HTML provider (203) and preview renderer (204) configured to generate shareable content, including HTML pages and graphical representations of feedback displayed via dashboard admin (106). The rendered content is formatted to ensure compatibility across digital platforms (304).
External sharing mechanisms are configured to facilitate sharing through structured metadata and generate unique URLs for public access via browser (305).

The claimed subject matter uses the interaction flow disclosed below to provide automated processing and sharing of user-generated ratings:
Step of agent and user interaction. The system initiates by enabling an agent (101) to communicate with an end-user (109) in a chat session (102). Post-interaction, the user (109) is prompted to provide feedback through an integrated assessment form (108).
Step of feedback collection. The system captures ratings and textual comments provided by the user (109) via chat assessment form (108). This feedback is temporarily stored in the chat session module before being processed by the assessment manager (107).
Step of feedback processing and storage comprising.
   collected feedback is transferred to the assessment manager (107), where it undergoes validation and processing (301). This module is configured to ensure that all data adheres to quality and format standards before storing it in the database (104).
   Database (104) management where feedback data is stored in structured tables to facilitate quick access and retrieval, including chat history (201) and assessment preview renders (202). The database (104) is designed to scale according to the volume of content without compromising its performance.
Step of content visibility and sharing comprising:
   Visibility status check further comprising the assessment manager (107) checks the current visibility status of the feedback (302). If feedback is not publicly available, the system updates its status to make it accessible for external sharing (305).
   URL generation and metadata integration where a unique URL is generated for each feedback entry, and structured metadata (for example title, description, image link) is prepared to enhance display across social platforms.
   Graphical representation (display) where the HTML provider (203) generates a branded image that accompanies the feedback. This image is embedded into the HTML page, ensuring a consistent appearance on the external website (305) accessed via browser (304).
Step of external sharing mechanisms comprising:
   Pre-filled messages and copy options where the system prepares pre-filled messages that include the feedback URL and metadata, simplifying the sharing process. Users can also copy URLs using the Clipboard API for manual sharing.
   Platform compatibility where the system is configured to support sharing on various external platforms (305), maintaining content accuracy and format consistency.

The first embodiment of the invention is focused on the customer service integration of feedback. This embodiment of the invention highlights its application within a customer service environment to capture, process, and share user feedback effectively. The system begins with the interaction between a customer service agent and an end-user facilitated by the active chat session module, which manages real-time communication through the live chat handler (103). After the chat session (102) concludes, the system prompts the end-user to provide feedback via the chat assessment form (108) integrated into the chat window (110). This form captures both ratings and comments from the user and sends them to the assessment manager for validation and processing. Once validated, the feedback is securely stored in the chats history database (201), ensuring it is readily available for future reference. The assessment manager (107) allows authorized agents to review the stored feedback and initiate the process to make it publicly accessible via an external website (305). If the feedback is private, the system updates its visibility status to public. The HTML provider (203) then generates a unique URL that directs to an HTML page embedding the user's feedback, complete with structured metadata to ensure optimal display.

Additionally, the assessment preview renderer (202) creates a branded graphical representation of the feedback, enhancing its professional presentation. Agents (101) can share the feedback through pre-filled messages or by copying the generated URL for manual sharing. The final output, when accessed, is a consistent, branded page that presents the user's feedback authentically.

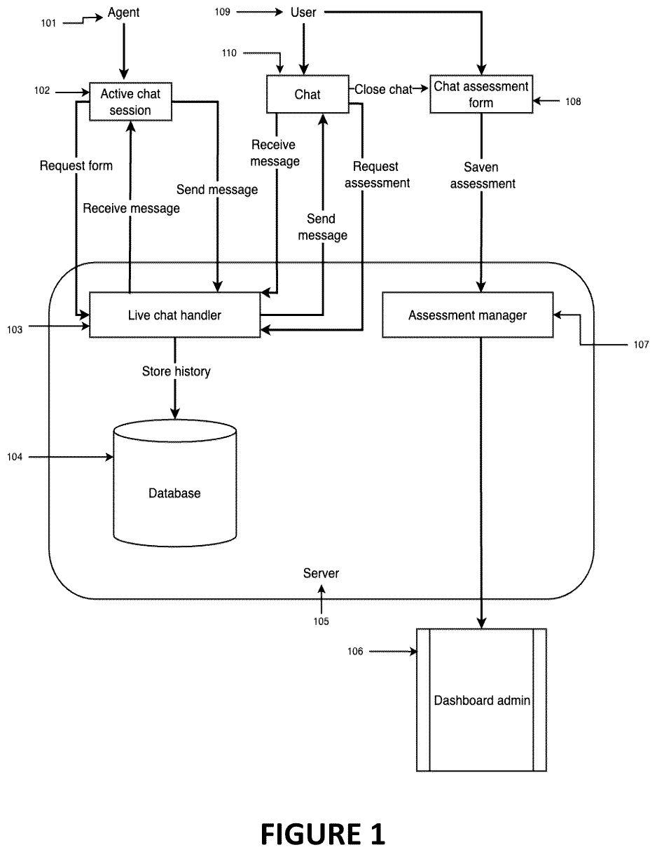

FIG. 1 illustrates the process of generating and sharing user-generated feedback through a system comprising interconnected components that facilitate data management and external distribution. The process begins with the server (105), which houses the assessment manager (107). The dashboard admin (106) initiates a request to access all agents' chat assessments (301). This interaction enables the dashboard admin to retrieve relevant data and open specific assessment details (302), from which a shareable link can be created. The assessment manager (107) processes this request and returns the shareable link to the admin. The HTML provider (203) formats the assessment data into a rendered HTML file. This rendered HTML is then requested by the browser (303) and subsequently displayed as a loaded webpage (304), completing the sharing process and enabling user interaction on an external website (305).

The next embodiment of the invention discloses product launch event collection and analysis. This embodiment demonstrates the system's capabilities during a high-traffic product launch event, where capturing and managing user feedback efficiently is crucial. The active chat session module (102) and live chat handler (103) facilitate numerous real-time conversations between event representatives (agents, 101) and end-users (109). Following interactions, users are prompted to provide feedback via the chat assessment form (108), which collects both qualitative and quantitative data and sends it to the assessment manager for processing (107). The system validates the feedback and organizes it within the chats history database (201), supporting high concurrency and rapid access even under heavy traffic conditions. To optimize performance during large events, the assessment preview renderer pre-generates rendered versions of the feedback for instant display, thereby reducing server load during subsequent requests. Marketing representatives can use the assessment manager to review and initiate the sharing of feedback, generating unique URLs with structured metadata and branded graphical content created by the HTML provider (203). The system's integration with APIs ensures that feedback can be seamlessly shared across various external platforms, maintaining consistent and accurate content representation on social media and other web platforms.

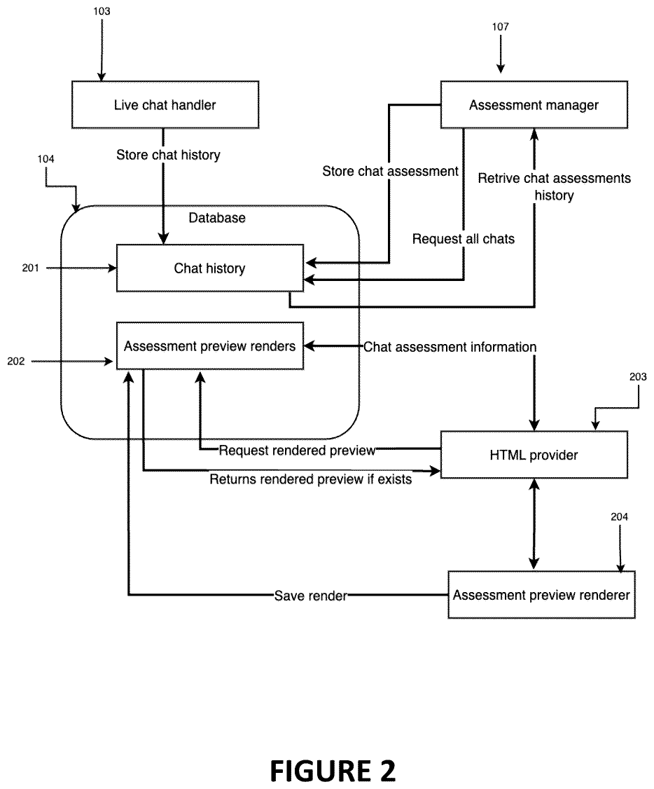

FIG. 2 outlines the interaction between the agent (101), user (109), and server (105) during a live chat session that involves feedback collection. The active chat session (102) module facilitates real-time communication between the agent and user, mediated by the live chat handler (103). Messages sent and received during the chat are processed through this handler. Upon the conclusion of the chat, the user is prompted to complete a chat assessment form (108). The completed assessment is submitted to the assessment manager (107), which processes the data. This information is then stored in the database (104) for future access. The dashboard admin (106) interacts with the server (105) to review or manage the feedback stored in the database, ensuring that the data flow from real-time communication to storage and administrative access is seamless.

A third embodiment of the invention discloses the use of internal performance monitoring. This embodiment describes how the system can be employed to monitor and improve agent performance through collected user feedback. The active chat session module facilitates real-time communication between agents and end-users, while the chat assessment form captures user feedback post-interaction. This feedback is transmitted via the live chat handler (103) to the assessment manager (107), that validates and processes it before organizing it within the chat history database (104). The feedback, once stored, can be used by quality assurance teams to monitor agent performance. The assessment manager allows authorized users to filter and review feedback by its details (302) according to various criteria, such as ratings or specific agents or all agents'ratings (301). The HTML provider (203) can generate internal reports or shareable previews for managerial review, utilizing the assessment preview renderer to create consistent and professional displays. This embodiment showcases how the system not only collects feedback but also supports the internal processes that help improve service quality and agent training. The integration of user feedback into performance reviews ensures that agents receive real-time insights into their service quality, fostering continuous improvement and customer satisfaction.

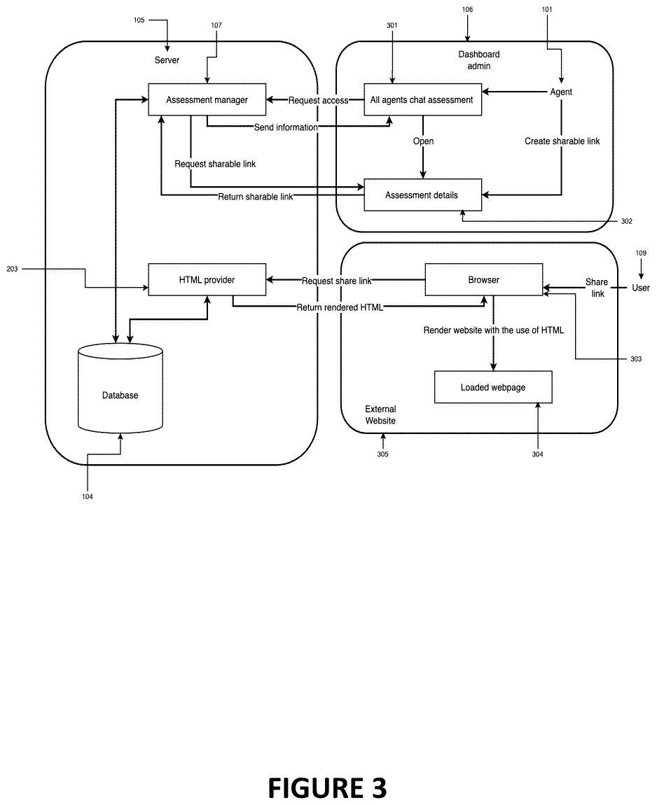

FIG. 3 shows the process of data retrieval and assessment rendering. The live chat handler (103) stores chat history in the database (104). The chat history module (201) organizes and maintains stored interactions for easy access. When feedback assessments are needed, the assessment manager (107) retrieves the chat history and initiates a request for assessment details. The information is processed and sent to the assessment preview renders module (202), which collaborates with the HTML provider (203) to create a rendered preview of the feedback. If a rendered preview already exists, it is returned; otherwise, a new preview is generated and saved. The assessment preview renderer (204) finalizes this process, ensuring formatted previews are accessible for review and visualization by authorized personnel.

The next embodiment demonstrates the application of the invention within an educational platform environment, focusing on the collection, processing, and dissemination of student feedback for course and instructor evaluation. The active chat session module facilitates real-time communication between students and instructors during live classes or interactive sessions. Upon the conclusion of a session, students are prompted to submit feedback via an embedded chat assessment form that collects ratings and comments regarding their learning experience. The live chat handler (201) transmits this feedback to the assessment manager (107), where it undergoes thorough validation to ensure the data meets quality and content standards. Once validated, the feedback is stored in the chats history database (104), providing secure and easily retrievable access for authorized educational staff. The assessment manager (107) enables instructors and administrators to review the stored feedback and determine whether it should be made publicly accessible for prospective students or internal use. When a feedback entry is approved for public sharing, the HTML provider (203) generates a unique URL linked to an HTML page showcasing the feedback (304).

The assessment preview renderer (202) creates a branded graphical representation that ensures a professional and consistent display, aligning with the educational institution's branding. This visual content, combined with structured metadata, optimizes how the feedback appears when shared on educational forums, social media, or the institution's website. The system supports automated sharing via pre-filled messages or allows manual copying of the URL through the clipboard API. This ensures that feedback highlighting positive learning experiences can be shared efficiently, enhancing the institution's credibility and attracting prospective students. Additionally, administrators can use the feedback data to assess instructor performance and make informed decisions about course improvements, promoting a higher standard of education.

The next embodiment of the invention discloses a method for automated processing and dissemination of user-generated feedback which begins with the user interaction module, where real-time communication occurs between an end-user and an agent. Following the interaction, the end-user submits feedback through the feedback collection interface, which captures ratings and textual comments. This collected data is then transmitted to the feedback validation and processing unit, where it undergoes a validation process to ensure compliance with predefined quality and content standards. Once validated, the feedback is securely transferred to the database storage system. This system is responsible for organizing and storing the feedback data in a structured format, allowing it to be accessed and managed efficiently. The database storage (104) system interacts with the assessment dashboard, providing authorized personnel with the capability to review, assess, and take necessary actions on stored feedback. Concurrently, the method includes a step where validated feedback is processed by the HTML rendering engine (203). This engine creates a branded, formatted representation of the feedback, complete with structured metadata to enhance display consistency across various platforms. The generated output is then linked to a public access link, which serves as a gateway for external visibility. The method culminates with the external sharing module (305), which facilitates the dissemination of feedback. This module ensures that user-generated content, once rendered (202), can be shared on digital platforms, maintaining authenticity and brand integrity through the structured metadata embedded during the rendering process. By integrating these components, the method effectively streamlines the entire lifecycle of feedback collection, processing, storage, and distribution, ensuring efficiency and consistency in managing user-generated content.

Having described some aspects of the present disclosure in detail, it will be apparent that further modifications and variations are possible without departing from the scope of the disclosure. All matter contained in the above description and shown in the accompanying drawings shall be interpreted as illustrative and not in a limiting sense.

What is claimed is:

1. A system for automated processing and sharing of user-generated feedback within a digital communication platform, comprising:
a user interaction module configured to facilitate real-time communication between at least a first user and an end user within an active chat session,
a chat assessment form configured to capture user ratings and comments following a communication between at least the first user and the end user within the active chat session,
a feedback validation and processing unit configured to validate and process feedback collected from the end user;
a live chat handler configured to communicate with a database storage system to store active chat session history,
the database storage system configured to store validated feedback and active chat session history,
an assessment manager comprising a display module for assessment details and further comprising a sharable link module to create a sharable link,
an HTML rendering engine configured to generate a public access link with branded feedback representation and structured metadata,
an external sharing module configured on the assessment manager and configured to enable sharing of the generated feedback across external digital platforms,
wherein the assessment manager is configured to provide authorized personnel access to review and manage stored feedback,
wherein the external sharing module is configured to communicate with a browser, and
wherein the external sharing module is configured to communicate with the HTML rendering engine to render a website with the use of HTML.

2. The system of claim 1, wherein the chat assessment form is embedded within a live chat application and prompts end user with a customized survey form tailored to the interaction context, wherein:
the survey form includes options for rating the service, providing written comments, selecting pre-defined feedback categories; and
the chat assessment form can adapt its prompts based on user responses to enhance feedback detail.

3. The system of claim 1, wherein the feedback validation and processing unit performs automated checks is further configured to perform natural language processing to assess sentiment and flag inappropriate content, and the system is further configured to apply a scoring algorithm to prioritize feedback for review based on predefined criteria and alert an administrator if flagged feedback requires manual oversight.

4. The system of claim 1, wherein the database storage system is structured to support high concurrency and real-time data synchronization, ensuring minimal latency in feedback access and the system further comprises a data storage encryption to protect user privacy and a backup mechanism to ensure data integrity and prevent loss during high-load operations.

5. The system of claim 1, wherein the assessment manager is further configured to:
allow authorized users to annotate feedback, categorize it by type, and assign it to different teams for analysis,
include a real-time metrics and visual reports for trend analysis; and
wherein the authorized users can set automated alerts based on feedback trends to notify relevant departments.

6. The system of claim 1, wherein the HTML rendering engine further comprises:
a customization feature configured for branding adjustments such as color schemes, logos, and font styles,
wherein the engine can generate a preview of the rendered feedback for review before public sharing; and
wherein the engine supports multiple formats, including PDF.

7. The system of claim 1, wherein the external sharing module is configured to:
enable integration with social media APIs for direct posting of feedback links with formatted previews,
schedule automated postings at predefined times for optimal audience reach; and
wherein the module supports manual sharing options through shareable QR codes or customized link shorteners.

8. The system of claim 1, wherein feedback rendered by the HTML rendering engine is accessible on both desktop and mobile devices, ensuring a responsive design that adapts to various screen sizes.

9. The system of claim 1, further comprising a notification service that informs authorized users when new feedback is validated and ready for review or sharing.

10. A method for automated processing and sharing of user-generated feedback within a digital communication platform, comprising:
facilitating real-time communication within an active chat session between at least a first user and an end-user via a user interaction module;
capturing user ratings and comments through a chat assessment form following the communication between at least the first user and the end user;
validating the captured feedback collected via chat assessment form with the use of a feedback validation and processing unit;
storing the validated feedback and the active chat session in a database storage system,
enabling authorized personnel to review and manage stored feedback using an assessment manager;
displaying module for assessment details further comprising a sharable link module configured to create a sharable link to the first user;
generating a public access link with branded feedback representation and structured metadata using an HTML rendering engine;
sharing of the feedback across external platforms via an external sharing module configured on the assessment manager;
wherein the assessment manager is configured to provide authorized personnel access to review and manage stored feedback;
wherein the external sharing module is configured to communicate with a browser; and
wherein the external sharing module is configured to communicate with the HTML rendering engine to render a website with the use of HTML.

11. The method of claim 10, further comprising the steps of:
prompting the end-user for feedback through the chat assessment form interface embedded within a live chat window;
dynamically adjusts the type of feedback requested based on the interaction context; and
wherein the interface provides real-time suggestions to guide the end-user in submitting comprehensive feedback.

12. The method of claim 10, wherein validating the feedback further includes the steps of:
performing sentiment analysis to categorize feedback as positive, neutral, or negative,
wherein validation also includes checking for specific keywords that require administrator attention; and
wherein the validation unit routes flagged feedback to a manual review queue for further assessment.

13. The method of claim 10, further comprising the steps of:
organizing the feedback in the database storage system by categories such as interaction type, service agent, and date,
periodic data archiving to maintain optimal system performance; and
selectively cross-referencing feedback with related data.

14. The method of claim 10, wherein the assessment manager enables authorized users to annotate feedback, add tags, and create follow-up tasks based on user insights, and further supports exporting feedback data for use in third-party reporting tools.

15. The method of claim 10 further comprising the steps of:
generating a public access link configured to embedding metadata tags that optimize search engine visibility and social media display,
generating versions optimized for different devices by the HTML rendering engine; and
wherein the engine is configured to perform a customization step where users can adjust visual elements before finalizing the feedback presentation.

16. The method of claim 10, further comprising the steps of:
sharing the feedback through the external sharing module configured to format the content to match the standards of a target platform,
scheduling processing by the sharing module to automate the timing of feedback posts; and
wherein the module tracks and reports sharing metrics to evaluate feedback reach and user engagement.

17. The method of claim 10, wherein the feedback rendered by the HTML rendering engine is responsive and adapts to the screen size and resolution of the viewing device.

18. The method of claim 10, further comprising sending notifications to designated users when new feedback has been validated and prepared for review or sharing.
